(19) United States
(12) Patent Application Publication
(10) Pub. No.: US 2014/0278978 A1
(43) Pub. Date: Sep. 18, 2014

(54) SYSTEM AND METHOD FOR CUSTOMER ACQUISITION

(71) Applicant: BELLY INC., CHICAGO, IL (US)

(72) Inventors: Jay O'Connor, CHICAGO, IL (US); Paul Spiller, CHICAGO, IL (US); Logan LaHive, CHICAGO, IL (US); Craig Ulliott, CHICAGO, IL (US)

(73) Assignee: BELLY INC., CHICAGO, IL (US)

(21) Appl. No.: 14/216,320

(22) Filed: Mar. 17, 2014

Related U.S. Application Data
(60) Provisional application No. 61/799,145, filed on Mar. 15, 2013.

(51) Int. Cl. G06Q 30/02

(52) U.S. Cl. CPC G06Q 30/0255
USPC 705/14.53

(57) ABSTRACT

A customer acquisition system for targeting potential customers may comprise: a non-transitory data storage device having one or more databases embodied therein; a data transmission device; and a processor operatively coupled to the non-transitory data storage device and the data transmission device, wherein the processor is communicatively coupled with an on-site user device positioned at a merchant and configured to interact with a user via a customer interface apparatus, wherein the processor receives, via said on-site user device, user visit data reflecting the user's activities with the merchant during a visit, wherein the processor is configured to access an offer database stored to the non-transitory data storage device, the offer database comprising a plurality of offers, wherein the processor uses said user visit data to identify one or more of said plurality of offers to be sent to the user for consideration, and wherein the processor communicates said one or more of said plurality of offers to said user via said data transmission device.

### CROSS-REFERENCE TO RELATED APPLICATIONS

This application claims priority to U.S. Provisional Patent Application No. 61/799,145, filed on Mar. 15, 2013, entitled “System and Method for New Customer Acquisition,” by Jay O'Connor et al., which is hereby incorporated by reference in its entirety.

### TECHNICAL FIELD

The present invention relates to a technology platform which enables intelligent customer acquisition campaigns for businesses. The present invention also provides a technology platform that allows businesses to run non-cannibalistic new customer acquisition campaigns that target ideal customers and also track long-term return on investment.

### BACKGROUND

Businesses spend billions of dollars every year to drive new customers through their doors. This happens through numerous channels such as direct mail, TV ads, print ads, daily deals, email marketing, contextual ads, etc. However, such an approach is inefficient and unnecessarily costly because, of the population of audience individuals, only a subset would be interested in the advertised product or service.

Therefore, a need exists for a system and method for targeting and/or retaining specific individuals, or groups of individuals. Moreover, despite the prior attempts to improve new customer acquisition marketing campaigns, a need exists for a more intelligent way to identify potential customers that (1) are new and important to the business; and (2) have a high probability of becoming loyal customers. For instance, if a business runs a daily deal campaign, the most loyal customers from that business could purchase the daily deal. These customers are not new to the business, and the heavy discount may not change their purchasing behavior. Depending on the merchant, this is often an inefficient use of marketing spend because a deep discount was provided to someone that is already a customer (i.e., cannibalistic) of that business and their purchasing behavior was not altered. Therefore, a system and method may also be provided for allowing businesses to target individuals that are not currently customers (non-cannibalistic) and that have similar characteristics to their already loyal customers.

### SUMMARY OF THE INVENTION

The present disclosure is directed to a technology platform that enables and facilitates new customer acquisition marketing campaigns.

According to a first aspect of the present invention, a customer acquisition system for targeting potential customers comprises: a non-transitory data storage device having one or more databases embodied therein; a data transmission device; and a processor operatively coupled to the non-transitory data storage device and the data transmission device, wherein the processor is communicatively coupled with an on-site user device positioned at a merchant and configured to interact with a user via a customer interface apparatus, wherein the processor receives, via said on-site user device, user visit data reflecting the user's activities with the merchant during a visit, wherein the processor is configured to access an offer database stored to the non-transitory data storage device, the offer database comprising a plurality of offers, wherein the processor uses said user visit data to identify one or more of said plurality of offers to be sent to the user for consideration, and wherein the processor communicates said one or more of said plurality of offers to said user via said data transmission device.

According to a second aspect of the present invention, a method for targeting potential customers comprises: receiving, at a computer via a data transmission device coupled to an on-site user device positioned at a merchant and configured to interact with a user via a customer interface apparatus, said user visit data reflecting the user's activities with the merchant during a visit, accessing, via said computer, an offer database stored to the non-transitory data storage device, the offer database comprising a plurality of offers, identifying one or more of said plurality of offers to be sent to the user for consideration, and communicating said one or more of said plurality of offers to said user via said data transmission device.

According to a third aspect of the present invention, a customer acquisition system for targeting potential customers comprises: a customer interface apparatus; an on-site user device positioned at a merchant and configured to interact with a user via said customer interface apparatus, wherein the on-site user device is configured to identify the user and to wirelessly communicate with the customer interface apparatus using a wireless transceiver; a customer acquisition server having a computer communicatively coupled to a non-transitory data storage device, the customer acquisition server being configured to communicate with said on-site user device over a communication network, wherein the computer receives, via said on-site user device, user visit data reflecting the user's activities with the merchant during a visit, wherein the computer is configured to access an offer database stored to the non-transitory data storage device, the offer database comprising a plurality of offers, wherein the computer uses said user visit data to identify one or more of said plurality of offers to be sent to the user for consideration, and wherein the computer communicates said one or more of said plurality of offers to said user via said communication network.

In certain aspect, the on-site user device may be configured to identify the user using an optical reader coupled to the on-site user device and QR Code positioned on the customer interface apparatus.

In certain aspect, the on-site user device may be configured to identify the user and to wirelessly communicate with the customer interface apparatus using a wireless transceiver.

In certain aspect, the processor may identify said one or more of said plurality of offers by: (1) determining the merchant's category of goods or services; and (2) identifying one or more of said plurality of offers by other merchants having the same category of goods or services.

In certain aspect, the processor may identify said one or more of said plurality of offers by: (1) determining the merchant's location; and (2) identifying one or more of said plurality of offers by other merchants having a location within a predetermined distance of said merchant's location.

In certain aspect, the processor may identify said one or more of said plurality of offers by: (1) determining the merchant's category of goods or services; (2) determining the merchant's location; and (3) identifying one or more of said plurality of offers by other merchants having (a) the same category of goods or services and (b) a location within a predetermined distance of said merchant's location.

In certain aspect, the processor stores said user visit data to a user profile database stored to the non-transitory data storage device, the user profile database comprising a plurality of user profiles. At least one of said plurality of user profiles may comprise historic visit data reflecting user visit data associated with the user's prior transactions with the merchant or other merchants. Accordingly, the processor may identify said one or more of said plurality of offers by: (1) accessing historic visit data associated with the user's user profile; (2) determining, from said historic visit data, two or more categories descriptive of the user's prior transactions; and (3) identifying one or more of said plurality of offers by other merchants matching said two or more categories descriptive of the user's prior transactions.

In certain aspects, weight may be assigned to at least one of said two or more categories descriptive of the user's prior transactions, thereby giving greater significance to said at least one of said two or more categories when identifying one or more of said plurality of offers by other merchants.

According to another aspect of the present invention, the system may be configured to (1) estimate or identify a location of a person through previous visit information; (2) estimate or identify a person's preference toward certain categories of locations, such as coffee shops or sports memorabilia stores; (3) estimate or identify a person's desire and likelihood to visit a location of a known category and location; (4) estimate or identify a person's desire and likelihood to visit a location where a visit has already occurred; (5) estimate or identify a person's desire and likelihood to visit a location based on past visits of other locations; and (6) estimate or identify a person's desire and likelihood to visit a location based on past records of system interaction on the server.

According to another aspect of the present invention, the system may employ a weighting model in which users can enter (or a system can prescribe) multipliers to factors either about a user's past interaction with similar businesses, the same businesses, or different businesses. The system may employ a weighting model in which users can enter (or a system can prescribe) multipliers to factors either about a campaign alone or statistics regarding a user and its interaction with that campaign.

According to another aspect of the present invention, the system may detect when an email has been forwarded through metadata associated with the requests for media within that email and records of previous metadata from prior requests.

According to another aspect of the present invention, the system may detect when a user has in the past, been sent communications, such as emails, regarding campaigns or other advertisements for goods or services.

### DESCRIPTION OF THE DRAWINGS

These and other advantages of the present invention will be readily understood with reference to the following specifications and attached drawings wherein:

FIG. 1a illustrates an example Customer Acquisition Network configured to facilitate customer acquisition functionality.

FIG. 1b illustrates an example merchant store plan having a wirelessly enabled on-site user device.

FIG. 2 illustrates an example method of checking-in at a merchant using a Customer Acquisition Network.

FIG. 3 illustrates an example method of updating client information.

FIG. 4 illustrates a first example method of detecting when an email is forwarded.

FIG. 5 illustrates a second example method of detecting when an email is forwarded.

FIG. 6 illustrates a first example method of rewarding a user for sharing an invitation with a second user.

FIG. 7 illustrates a second example method of rewarding a user for sharing an invitation with a second user.

### DETAILED DESCRIPTION

People are continuously searching for new experiences and merchants are continuously searching for way to attract new customers. A customer acquisition platform, such as the system available from Belly®, gives merchants insight into redemptions and repeat visits, so merchants know exactly how many new customers they are gaining. The customer acquisition system and method, which may be facilitated through a customer acquisition platform, enables discovery and sharing of stored rewards received via push channels (SMS, email, Internet, Facebook®, Push Notification). For this disclosure, the following terms and definitions shall apply:

As used herein, the word “exemplary” means “serving as an example, instance, or illustration.” The embodiments described herein are not limiting, but rather are exemplary only. It should be understood that the described embodiments are not necessarily to be construed as preferred or advantageous over other embodiments. Moreover, the terms “embodiments of the invention,” “embodiments,” or “invention” do not require that all embodiments of the invention include the discussed feature, advantage, or mode of operation.

The terms “communicate” and “communicating” as used herein include both conveying data from a source to a destination and delivering data to a communications medium, system, channel, network, device, wire, cable, fiber, circuit, and/or link to be conveyed to a destination. The term “communication” as used herein means data so conveyed or delivered. The term “communications” as used herein includes one or more of a communications medium, system, channel, network, device, wire, cable, fiber, circuit, and/or link.

The terms “coupled,” “coupled to,” and “coupled with” as used herein, each mean a relationship between or among two or more devices, apparatuses, files, circuits, elements, functions, operations, processes, programs, media, components, networks, systems, subsystems, and/or means, constituting any one or more of (1) a connection, whether direct or through one or more other devices, apparatuses, files, circuits, elements, functions, operations, processes, programs, media, components, networks, systems, subsystems, or means; (2) a communications relationship, whether direct or through one or more other devices, apparatuses, files, circuits, elements, functions, operations, processes, programs, media, components, networks, systems, subsystems, or means; and/or (3) a functional relationship in which the operation of any one or more devices, apparatuses, files, circuits, elements, functions, operations, processes, programs, media, components, networks, systems, subsystems, or means depends, in whole or in part, on the operation of any one or more others thereof.

The term “data” as used herein means any indicia, signals, marks, symbols, domains, symbol sets, representations, and any other physical form or forms representing information, whether permanent or temporary, whether visible, audible, acoustic, electric, magnetic, electromagnetic, or otherwise manifested. The term “data” is used to represent predetermined information in one physical form, encompassing any and all representations of corresponding information in a different physical form or forms.

The term “database” as used herein means an organized body of related data, regardless of the manner in which the data or the organized body thereof is represented. For example, the organized body of related data may be in the form of one or more of a table, map, grid, packet, datagram, frame, file, email, message, document, report, list, or in any other form.

The term “network” as used herein includes both networks and inter-networks of all kinds, including the Internet, and is not limited to any particular network or inter-network.

The term “processor” as used herein means processing devices, apparatuses, programs, circuits, components, systems, and subsystems, whether implemented in hardware, tangibly embodied software or both, and whether or not programmable. The term “processor” as used herein includes, but is not limited to, one or more computing devices, hardwired circuits, signal-modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, data processors, processing facilities, and combinations of any of the foregoing.

The term “computer” as used herein means a device, or collection of devices, having a processor and enabled to perform one or more prescribed mathematical and/or logical operations.

The term “point-of-sale device” as used herein refers to a computerized device or system for facilitating a sale and/or transaction and, in certain situations, managing storing data related to the sale and/or transaction.

The term “merchant” refers to any entity or person engaged in the sale of commodities, products, and/or services.

As described herein, a customer acquisition platform may use a combination of customers' demographic information, which may be provided via social media networks (e.g., a Facebook® sign-in), and information (e.g., data) gathered by the customer acquisition platform regarding the customers' behavior.

Based upon a customer's demographic information, targeted offers (e.g., coupons, discounts, vouchers, etc.) may be provided to a specific individual, or group of individuals, for consideration. In operation, a merchant may simply provide the customer acquisition platform with data descriptive of a desired customer pool—for example, a tailor may ask for men, ages 45 to 65. Accordingly, various customer groups may be generated from a pool of individuals based upon one or more common demographics. These customer groups may be used and scored to target customers as new offers are made available. For example, a database may contact a plurality of customer groups, each group representing one or more demographics. The customer groups may be static (e.g., unchanging) or configured to update periodically as new customers are acquired and/or as customer demographics change.

In certain embodiments, the targeted offers may also be carefully designed to not target existing customers or a competitive business's existing customers. Indeed, the customer acquisition platform may be configured to remove individuals from the customer groups who are known to be existing customers of a particular merchant, or group of merchants.

The customer acquisition platform may also mitigate another problem facing retailers running other customer discovery campaigns—that a massive spike in new customers immediately following a promotion can overwhelm a business. This is a complaint often heard in the daily deals market, when a multitude of foot traffic comes in for a discounted promotion, but never returns. Instead, the customer acquisition platform can be used to pace the influx of new customers based on what the merchant believes it can handle during that week or month. That is, the customer acquisition platform may be configured to send only a predetermined number of targeted offers within a given time period and, depending upon the number of targeted offers redeemed, additional targeted offers may be sent during the given time period or at a later time.

Merchants working with a customer acquisition platform may specify a number of target parameters, such as the number of new customers they want to acquire, an average basket size (i.e., total units sold divided by the number of invoices), a desired return on investment (“ROI”), and other factors relevant to the merchant's campaign. These target parameters may be used by a vendor (i.e., a vendor providing the customer acquisition platform) in determining any service charges to the merchant. To increase reliance, the customer acquisition platform may adopt a “pay-for-performance,” model, meaning, if a new customer doesn't redeem the offer, the merchant doesn't pay for the service. For example, the merchant may pay the vendor on a performance basis for each acquired customer, as opposed to paying based on the size of the target audience when the targeted deals may not be redeemed.

For example, a customer acquisition platform may be used to enable a free sample program. Accordingly, merchants (e.g., small- and medium-sized merchants) may elect to offer potential customers a promotional item, like a free latte or haircut, in hopes of luring them into the merchant's store and ultimately establishing that potential customer as a regular customer. The redeemable coupons (or “targeted offers”) may go out to potential customers either via an email list or on a website. The targeted offers may be redeemed via a smartphone application, or using a universal loyalty card, as opposed to often lost or neglected paper punch cards.

The customer acquisition platform may enhance a customer's point-of-sale experience by providing a customer-facing device (e.g., a tablet computer) at a merchant's business, thereby enabling customers to enter their own personal information, such as an email address or phone number, during a transaction. The customer-facing device may also facilitate payment options (e.g., by linking a credit card with the customer acquisition platform), and/or posting to Social Media Networks. Moreover, as will be discussed in greater detail below, the customer-facing device may be configured to wirelessly interact with individuals (e.g., customers and/or potential customers).

Accordingly, a customer acquisition platform provides a merchant with the ability to attract potential customers (e.g., individuals of a Network, such as the Belly® Network) who have yet to visit the merchant. Accordingly, the customer acquisition platform may send a targeted email containing one or more offers to a group of potential customers specified by a merchant (e.g., based on customer demographic criteria) or identified by the customer acquisition platform (e.g., based on prior behavior), thereby ensuring that the merchant's offer is seen by potential customers who are more likely to be interested.

Thus, as disclosed herein, a customer acquisition platform enables merchants to attract new customers by providing a targeted offer, which may be a free or discounted product or service, such as appetizers or free haircuts. The customer acquisition platform may communicate the offer to potential customers using, for example, a website and/or mobile applications, as well as email or SMS texting. The mobile application may be installed on a mobile device, such as a laptop, smart phone, or tablet computer. Through a mobile application, potential customers may elect to view their offers in addition to, or in lieu of, receiving push notifications, as push notifications are often dismissed by the potential customers as spam.

The customer acquisition platform can also reduce a merchant's advertising costs while increasing a loyal customer base. Indeed, by employing a customer acquisition platform, the merchant will not need to apply as many resources towards advertising. Moreover, the customer acquisition platform may be configured to target potential customers who have not yet been to the merchant, thereby not wasting efforts on customers who already support a particular merchant. Therefore, rather than running daily ads or printing flyers, a merchant may use a customer acquisition platform to target potential customers, whereby only new potential customers are targeted, and the merchant may only be charged for offers that are actually redeemed by new potential customers.

Therefore, in operation, a merchant may choose as a targeted offer a product or service that showcases the merchant's business and/or provides such product or service to a new customer as a sample. The customer acquisition platform geographically targets potential customers in the merchant's region, featuring the merchant via the Internet, email, and/or mobile application. Alternatively, a targeted offer may be wirelessly facilitated through push notifications, wireless location-based push notification deals in-store (e.g., low frequency-based Bluetooth), a search on a web catalogue, or through other social networking media (e.g., a reward from a Facebook® or Twitter® advertisement), e-wallets (Google® Wallet™, Passbook™), and/or other mobile notification media, etc. In certain embodiments, while the targeted offer may be facilitated by a third-party provider of the customer acquisition platform, the targeted offer may be designed so as to appear to be sent directly from the merchant. For example, an email or push notification may be designed to appear as if Molly's Cupcakes sent it, not Belly

Upon receipt, a potential customer may add the merchant's targeted offer to the potential customer's account. Essentially, the customer acquisition platform may be configured to (1) identify potential customers that would be interested in the targeted offer; and (2) direct the potential customers to the merchant using the offer.

From the potential customer's perspective, the potential customers may receive notification of a targeted offer though their phone, email, computer, etc. The potential customer may be presented is one or more offers for the potential customer to add to the account. For example, the potential customer may be presented with five to ten offers that the customer acquisition platform determined would be of greatest interest to the potential customer.

In evaluating a potential customer's interest (e.g., identifying potential customer groups to target) the customer acquisition platform may consider factors such as (1) number of merchants frequented; (2) types of merchants frequented; (3) location or locations of merchants frequented; and/or (4) times of day when a certain merchant is visited. Additional data about a customer may be acquired from social media networks (e.g., Facebook®/Twitter®), from email domains, or by querying the user or through tracking users' spending habits. For example, a user may choose to link to the customer acquisition platform through a social media network profile to provide additional information to the customer acquisition platform about the user's preferences and interests. Any received customer data may be either stored (cached) or dynamically pulled as new offers are made available. For example, known/static data, such as birthday and gender may be cached; as such data is unlikely to change. However, it may be advantageous to update cached information related to more dynamic data, such as interests and recent locations, as this is dynamically changing. Indeed, for more dynamic data, the information may be queried as needed (e.g., real time). Alternatively, the data may be cached, but updated regularly, (e.g., daily). To search the data, one or more search methods may be used. For example, NoSQL may be used for faster results, at the expense of greater data usage, while a relational database management system (“RDBMS”) may be used for slower searching, but with more effective use of data.

The collected data may also be used to predict or estimate other data. For example, if the customer acquisition platform determines that 80% of patrons to merchant X are female, it would be reasonable to assume that a person of unknown gender is female, or at least expresses an affinity to merchants catering to feminine clientele. Thus, that person's account may be flagged as “female” for the purpose of targeting new offers.

The customer acquisition platform may also identify the potential customer's livable region. Thus, while a customer may live in region X, if it is determined that the customer spends more time and money in region Y, it would be advantageous to submit offers related to region Y, even if that customer may not live there.

Once the potential customer has added a deal to their account, the potential customer may visit the merchant where the offer is ready and waiting. Indeed, to redeem the offer, the potential customer may use a computing device (e.g., a laptop, tablet computer, or smart phone) to present the deal to the merchant. For example, a device may be set up at the location of the merchant (e.g., in-store/on the premises) with a message to touch an icon (e.g., “Tap to Belly®”) on the tablet screen. Once the potential customer selects the icon, the user may scan a matrix barcode (e.g., a Quick Response Code, or “QR Code”), or other code (e.g., a Universal Product Code (“UPC”)), printed to a membership card. Alternatively, the user may use a mobile device to display a code that may be scanned or wirelessly communicate with the tablet using, for example, near field communication (“NFC”), Bluetooth®, etc. Thus, optical readers and wireless transmitters/receivers/transceivers may be employed to identify a customer. After which, a targeted offer may appear after the potential user has redeemed a targeted offer at that business on on-site user device, such as an in-store computer/tablet. Indeed, the on-site user device may be communicatively coupled with, or integrated with, the merchant's point-of-sale device (e.g., a cash register) to automatically deduct the deal.

Thus, once a potential customer selects/adds a targeted offer to his account for Mexican Restaurant A, that customer need only arrive at the restaurant with his membership card and/or application software. Upon checkout, the potential customer may scan his QR code via the in-store device. The in-store device may either display the deal to the cashier, which then may be manually deducted. Alternatively, the in-store device may automatically deduct the value of the offer from the bill using a communication link between an in-store device and a point-of-sale device (e.g., a cash register). For example, if a potential customer's account indicates that he has been to five Mexican restaurants in the past two months, and four of the five are on the north side of Chicago, the customer acquisition platform may conclude that that potential customer spends time on the north side of Chicago and is interested in Mexican food. Therefore, any offers relating to Mexican restaurants, or other similar style of food, may be communicated to the potential customer via the customer acquisition platform.

Alternatively, rather than using an optical method, such as scanning a QR code, other technologies, such a wireless transceiver (e.g., one using near field communication (“NFC”)), may be used to identify, and/or sense the presence of, the customer in the merchant's establishment. NFC is a set of standards for smartphones and similar devices to establish radio communication with each other by touching them together or bringing them into close proximity, usually no more than a few centimeters. Other technologies include, for example, GPS. However, because it is important to confirm that the user is in the merchant's establishment, it is important to ensure that the GPS is accurate enough such that a user inside the store may be distinguished from a user standing near the store. Such wireless technology may also be used to automatically detect and communicate with a potential customer within range of the in-store device. For example, the in-store device may automatically push certain targeted offers to a potential customer or track the number of individuals to come within range of a particular location.

Additionally, the customer acquisition platform may even consider other factors, such as the location and time of day associated with one or more visits. For example, if a potential customer frequents fast food restaurants located in the loop during lunch time, but suburban Mexican restaurants at night and on weekends, the customer acquisition platform may submit offers related to loop lunch deals and suburban Mexican restaurant dinner deals.

Moreover, the customer acquisition platform may even assign weights to certain factors, to better target potential customers. For example, if a new offer matches three categories, such as Category 1, Mexican food; Category 2, downtown Chicago; and Category 3, young, single crowd, certain factors may be more important to potential customers. For instance, while an older couple may live in downtown Chicago and may enjoy Mexican food, they might not be inclined to go to a loud, noisy singles restaurant. Thus, the Category 3 might be considered more important, thus given a greater multiplier.

Accordingly, offers with the highest score may be displayed to the potential customer. For example, if there are 1,000 available offers, only the top 5 to 10 available offers may be displayed to a certain group of people. In selecting the offers to display, the sum of each category may be used to serve as a match score. Thus, if a targeted offers has ten qualities (Quality 1 to Quality 10), the score assigned to those ten qualities may be added to yield the match score. The ten qualities may have equal weights, or disproportionate weights, if one quality is more important than another.

To facilitate quality control, the different, weighted categories may be tested on portions (e.g., subsets) of a customer population to determine whether the weights assigned to one or more categories should be adjusted to attract more clicks (e.g., selections by the users) or other action indicating interest. For example, if there are 1,000 customers in a population fitting a similar demographic (e.g., male, ages 18 to 25, and in downtown Chicago), a set of categories having Weight Set 1 may be sent or otherwise communicated to 500 customers and the same set of categories, but having Weight Set 2, may be sent or otherwise communicated to the other 500 customers. The customer acquisition platform may then measure the number of clicks on a particular offer, or whether the email was opened. Thus, the customer acquisition platform may determine that Weight Set 2 was more effective in targeting customers. To further refine the Weight Sets, the process may be repeated using Weight Set 2 and new Weight Set 3. However, because Weight Set 2 is known to be effective, the ratio may be adjusted such that 80% of a particular population received Weight Set 2, while the remaining 20% receives the “experimental” Weight Set 3. Again, the cycle may be further refined until the number of clicks or views by the customers is maximized.

To enhance merchant business, and to increase the number of participating merchants, the customer acquisition platform may be configured to display relevant offers to potential customers, unless those offers would interfere with a particular participating merchant. For example, if a user creates an account with the customer acquisition platform via a hamburger merchant in region A, the customer acquisition platform may be configured to not display other competing hamburger merchants in region A, thereby reducing any reluctance of the hamburger merchant from participating in the customer acquisition platform.

FIG. 1a illustrates an example Customer Acquisition Network 100a configured to facilitate customer acquisition functionality. As illustrated, the Customer Acquisition Network 100a may comprise a Communication Network 106 (e.g., the Internet) that is communicatively coupled, via a data transmission device, with, for example, a Customer Acquisition Server 102, one or more on-site user device 104s, Point-of-Sale Devices (“POS Device”) 112, and customer interface apparatus 114. The data transmission device may be a wireless data device, such as a wireless transceiver, a wired connection, or a combination thereof. Example customer interface apparatus 114 include mobile devices 110 (e.g., smart phones, computers, etc.), and membership cards 108.

The Customer Acquisition Server 102 may be used to facilitate customer-merchant matching and offer functionality for the Customer Acquisition Network 100a. An exemplary Customer Acquisition Server 102 may comprise a processor (e.g., via computer 102a) configured to perform one or more algorithms/protocols and a non-transitory data storage device 102b. The computer 102a may be communicatively and operatively coupled with one or more non-transitory data storage devices 102b, which may be a non-transitory, computer-readable medium having one or more databases and/or computer-executable instructions embodied therein. The computer-executable instructions, when executed by the computer, facilitate the various above-described customer-merchant matching and offer functionality. Thus, computer 102a may be communicatively coupled with the on-site user device 104 positioned at, for instance, a merchant 116 and configured to interact with a user. The non-transitory data storage device 102b may be further configured to store data about one or more customers and/or merchants. For example, computer 102a may be configured to access an offer database stored to the non-transitory data storage device 102a, and/or a user profile database stored to the non-transitory data storage device. The offer database may comprise one or more targeted offers while the user profile database may comprise a plurality of user profiles. Thus, computer 102a may be configured to match a user with said one or more targeted offers using the above-described matching methods.

For example, computer 102a may identify one or more targeted offers to be provided to the user by: (1) determining the merchant 116's location and/or category of goods/services; and (2) identifying one or more of said plurality of offers by other merchants having (a) a matching (e.g., the same, similar, or related) category of goods or services and/or (b) a location within a predetermined distance of said merchant 116's location. Moreover, the computer 102a may store said user visit data to the user profile database stored to the non-transitory data storage device, the user profile database comprising a plurality of user profiles. As discussed below, the user profiles may further comprises historic visit data reflecting a user's prior transaction with the merchant 116 and other merchants. Accordingly, computer 102a may identify one or more targeted offers to be provided to the user by: (1) accessing historic visit data associated with a user's user profile; (2) determining, from said historic visit data, two or more categories descriptive of the user's prior transactions (e.g., type of merchant, location, time visited, etc.); and (3) identifying one or more of said plurality of offers by other merchants matching said two or more categories descriptive of the user's prior transactions. As discussed above, a weight may be assigned to a category descriptive of the user's prior transactions, thereby giving greater significance (e.g., a first category is more deemed important by the computer in the analysis when compared to a second category) to said at least one of said two or more categories when identifying one or more of said plurality of offers by other merchants.

While the Communication Network 106 is illustrated as a single network, one of skill in the art would recognize that one or more communication networks may be used to facilitate communication between the various components of the Customer Acquisition Network 100a. Indeed, an encrypted communication channel, such as Secure Sockets Layer (“SSL”), may be employed to communicate data between, for example, the Customer Acquisition Server 102 and the on-site user device 104 and/or a customer interface apparatus 114.

The on-site user device 104 may be communicatively coupled with one or more POS Devices 112 (e.g., a cash register). Thus, site user device 104 may be configured to communicate, to computer 102a, user visit data reflecting the user's activities with the merchant 116. Accordingly, upon selecting a user account using the on-site user device 104, any offers applicable to the merchant 116 where the on-site user device 104 is located may be displayed or automatically applied to the total sale via the POS Device 112. For example, via an optical reader coupled with the on-site user device 104, a user may select his or her user account by scanning a QR code on a membership card 108, or use a mobile device 110 to display a QR code that may be scanned. Thus, the on-site user device is configured to identify a customer (e.g., determine one or more of a name, contact information, account information, etc.) using an optical reader and QR Code). Indeed, the on-site user device 104 may be communicatively coupled with, or integrated with, the merchant 116's POS Device 112 to automatically deduct or redeem the deal. Moreover, in certain embodiments, the functionality of the on-site user device 104 and the POS Device 112 may be facilitated through a single device.

FIG. 1b illustrates an example merchant 116 store plan 100b having a wirelessly enabled on-site user device 104. Indeed, the on-site user device 104 (or a POS Device 112 comprising on-site user device 104 functionality) may be configured to communicate directly with the customer interface apparatus 114. More specifically, the on-site user device 104 may be configured to wirelessly communicate with a membership card 108, or use a mobile device 110. Thus, the on-site user device may also be configured to identify a customer using a wireless transceiver. For example, the on-site user device 104 may employ wireless technology to detect one or more membership cards 108 within a particular area. The on-site user device 104 may detect the one or more membership cards 108 using, for example, Radio-Frequency Identification (“RFID”) technology, whether active or passive RFID. That is, the on-site user device 104 may be configured with an RFID reader, while the membership cards 108 may be equipped with RFID tags (e.g., embedded within the card).

In certain embodiments, the on-site user device 104 may be equipped with a wireless communication/data transceiver. The wireless communication transceiver/receiver may be low power so as to communicate only with mobile devices 110 within proximity of the on-site user device 104, such as NFC, Bluetooth, etc., or higher powered (or coupled to a network, such as the Internet via a cellular network), so as to communicate with distant user mobile devices. Accordingly, targeted offers may be wirelessly facilitated through location-based push notification deals in-store.

Wireless communication also enables merchants (e.g., merchant 116) to track the number of visitors, or users, to a particular location, even if the visitor does not make a purchase. For example, the on-site user device 104 may be configured to wirelessly detect any membership cards 108 (e.g., via RFID), or mobile devices 110 (e.g., via radio communication), in range of the on-site user device 104 without requiring the user to broadcast or otherwise share the location. As illustrated in FIG. 1b, the on-site user device 104 may be positioned towards the back of the store so as to not detect passing pedestrians, while detecting users 202 who are in-range of the on-site user device 104. The range of the on-site user device 104 detection may be adjusted depending on the desires of the merchant 116, size of the store, etc.

Indeed, the Customer Acquisition Network 100a can confirm that the customer who redeems a targeted offer is targeted according to requested specifications (e.g., the specifications provided by the merchant 116 in customer-targeting) and verified in-store. The user 202 may be verified as in-store through check-in, redemption of a stored reward via the on-site user device 104, and/or through the wireless tracking means illustrated in FIG. 1b.

The Customer Acquisition Server 202 may receive visit information through an encrypted communication channel, such as SSL, record the information sent into a database along with known information about the client, such as what location it belongs to, where the client is (geolocation information), and the value of the visit to the location. Generally speaking, geolocation is the identification of the real-world geographic location of an object, such as a radar, mobile phone or an Internet-connected computer terminal. The client periodically updates the server with information about itself, such as geolocation information and status information about its operating (errors encountered, key presses, touches, etc.). The server may then write the information to a database.

FIG. 2 illustrates an example method of checking-in using the Customer Acquisition Network 100a. For example, a user 202 (e.g., a customer or potential customer) establishes a visit 210 at a client 204 (e.g., a merchant). The visit may be established when, for example, the user checks in at the on-site user device 104 using a customer interface apparatus 114. Upon establishing the visit 210 at the client 204, the client requests authentication 212 of the user 202's credentials from a central data collection server 206 (e.g., the Customer Acquisition Server 102). Upon receipt, the server 206 may determine whether the user 202's credentials are valid and, if so, authenticates 214 the user 202. Once authenticated 214, the client 204 creates a visit 216, whereby the client 204 communicates user-identifying data, such as, an email address, and/or a unique identifier at the server 206 (e.g., an account number). The method of communicating user-identifying data with the client 204 may be, for example, through a unique code (e.g., a QR code) printed on a membership card that was optically scanned by the client 204 or through a wireless transceiver using a wireless means, such as NFC, Bluetooth, etc.

Upon creating a visit 216, the client 204 may also collect and communicate to the server 206 details (e.g., attributes) pertaining to the current visit and/or transaction. For example, details pertaining to the current visit and/or transaction may include the date and time of the visit or transaction, the user 202's unique identifier at the server, reason for the visit, method of communicating with the client 204, purchases made (e.g., type, quantity), monetary value of transaction, etc. The client 204 may communicate with the server 206 via, for example, communication network 106. The server 206 may further request historic visit data 218 from a data store 208. The data store 208 may be facilitated through a database stored to, for example, a non-transitory data storage device 102b coupled to a computer 102a at the Customer Acquisition Server 102. Alternatively, the data store 208 may be remotely located and available to the Customer Acquisition Server 102 over communication network 106.

If a request historic visit data function is available for the user 202, the server 206 may receive said historic visit data 220. Historic visit data may include, for example, the number of visits to a particular merchant, or category of merchant, and any details pertaining to prior visits and/or transactions with those particular merchants, or category of merchant. The server 206 may determine 222, via one or more processors, whether details pertaining to the current visit and/or transaction are available, and whether to write/update the data store 208 to reflect the current visit. For example, the server 206 may determine visit attributes to save to the data store 208 based on historic visit information, such as the ability to earn loyalty points. If the server 206 determines 222 to write/update the data store 208 to reflect the current visit, the server 206 will save details pertaining to the current visit and/or transaction to the data store 208 at Step 224.

Moreover, client information (e.g., client account data/contact information) may be updated periodically by the user 202 as set forth in FIG. 3. For example, if the user wishes to update an email address, the user 202 may use an on-site user device 104 (e.g., at the client 204) to enter the updated client information 302 (e.g., the new email address). The updated client information 304 may then be communicated from the client 204 to the server 206 via, for example, Communication Network 106, whereby the updated client information may then be stored to the data store 208.

Alternatively, at Step 306, the user 202 may wish to use a customer interface apparatus 114 (e.g., smart phones, computers, etc.) to enter the updated client information 302 (e.g., the new email address). The updated client information may then be communicated 304 from the customer interface apparatus 114 to the server 206 via, for example, Communication Network 106, thereby obviating the need to visit client 204. Accordingly, the Customer Acquisition Server 102 may be configured to gather data relating to behavior of users within the network 100 in order to facilitate future targeted offers through, for example, weighting models that intelligently identify predictive factors of future behavior and provide recommendations and filters by merchant that most effectively target the desired types of individuals.

While the Customer Acquisition Server 102 may be configured to detect the number of clicks or views of a targeted offer, the Customer Acquisition Server 102 may further be configured to detect whether an email has been forwarded or shared (e.g., using a social media network or via the Customer Acquisition Server 102 application).

An email can be determined to be forwarded (and subsequently, the offer shared) if the metadata (such as the originating IP or user agent of the requesting client) of a request that is completed after opening the email (such as loading an image or other media) is different (based on a predetermined difference threshold) from an earlier request or requests. FIG. 4 illustrates a first example method 400 of email-forwarding detection. At Step 402, an e-mail is sent by the Customer Acquisition Server 102 to one or more targeted customers. At Step 404, the user (i.e., the recipient) opens the email. Upon opening the email, images are loaded from the Customer Acquisition Server 102 at Step 406. The image loading process of Step 406 causes metadata associated with the request to be received by the Customer Acquisition Server 102 at Step 408. At Step 410, the Customer Acquisition Server 102 determines if metadata associated with the email has been previously received.

If no metadata has been previously received by the Customer Acquisition Server 102, at Step 412, the metadata is saved by the Customer Acquisition Server 102 to, for example, a non-transitory data storage device 102b, after which the process ends at Step 414. If metadata has been previously received by the Customer Acquisition Server 102, the received metadata is compared to the previously received metadata at Step 416. If the received metadata and the previously received metadata are the same, the process ends at Step 414. Since the metadata is the same, there may be no need to save it again to the non-transitory data storage device 102b. However, in certain aspects, it may be advantageous to the extent that the Customer Acquisition Server 102 wishes to track how many times an email has been opened.

If the received metadata and the previously received metadata are different, the Customer Acquisition Server 102 may conclude that the email was forwarded at Step 418. At Step 412, the received metadata may then be saved by the Customer Acquisition Server 102 to, for example, a non-transitory data storage device 102b at Step 412, after which the process ends at Step 414. The forward count (i.e., the number of times an email is determined to be forwarded) may also be saved to, or updated at, the non-transitory data storage device 102b at Step 412, after which the process ends at Step 414.

An email may also be determined to be forwarded (and subsequently, the campaign shared) if the originating geolocation of an IP address of a request that is completed after opening the email (such as loading an image or other media) is significantly different than earlier requests over a time period. For instance, if a user opens an email in Florida, USA, and ten minutes later the same image is requested from New York, USA the time between the two requests can be determined as too small to have traveled the distance between the origination of the requests. The predetermined distance/time threshold may be set by the Customer Acquisition Server 102 or the merchant. For example, a predetermined distance/time threshold of 500 miles per hour would indicate that any request made 500 miles or more away, but in one hour or less, will be considered a forwarded email.

FIG. 5 illustrates a second example method 500 of email forwarding detection. At Step 502, an e-mail is sent by the Customer Acquisition Server 102 to one or more targeted customers. At Step 504, the user (i.e., the recipient) opens the email. Upon opening the email, images are loaded from the Customer Acquisition Server 102 at Step 506. The image-loading process of Step 506 causes an IP address associated with the request to be received by the Customer Acquisition Server 102 at Step 508. At Step 510, the Customer Acquisition Server 102 determines if an IP address associated with the email has been previously received.

If no IP address has been previously received by the Customer Acquisition Server 102, at Step 512, the IP address is saved by the Customer Acquisition Server 102 to, for example, a non-transitory data storage device 102b, after which the process ends at Step 514. If an IP address has been previously received by the Customer Acquisition Server 102, the received IP address is compared to the previously received IP address at Step 516. If the received IP address and the previously received IP address do not exceed a predetermined distance/time threshold, the process ends at Step 514. Since the IP address is the same, there may be no need to save it again to the non-transitory data storage device 102b. However, in certain aspects, it may be advantageous to the extent that the Customer Acquisition Server 102 wishes to track how many times an email has been opened.

If the received IP address and the previously received IP address exceed a predetermined distance/time threshold, the Customer Acquisition Server 102 may conclude that the email was forwarded at Step 518. At Step 512, the received IP address may then be saved by the Customer Acquisition Server 102 to, for example, a non-transitory data storage device 102b at Step 512, after which the process ends at Step 514. The forward count (i.e., the number of times an email is determined to be forwarded) may also be saved to, or updated at, the non-transitory data storage device 102b at Step 512, after which the process ends at Step 514.

FIG. 6 illustrates an example method 600 of rewarding a user with a good or service which can be done after the user has shared a campaign or link with a contact. When the system recognizes that an email has been forwarded, or the link has been shared directly with another person (using common link tagging methods), it can reward the sharing user with a good or service.

For example, at Step 602, the Customer Acquisition Server 102 may request that an existing user (e.g., a first user) invite other users (e.g., a second user) to become members of the Customer Acquisition Network 100. The Customer Acquisition Server 102 may request that a first user to share an invitation with the second user at Step 602, via, for example, email, SMS, etc. At Step 604, the Customer Acquisition Server 102 may receive confirmation that the first user shared an invitation with second user. At Step 606, the Customer Acquisition Server 102 may create a record. That is, the Customer Acquisition Server 102 may store a record of the invitation for the second user to a non-transitory data storage device 102b coupled to the Customer Acquisition Server 102's computer 102a. At Step 608, the second user may accept the invitation from the first user. For instance, the second user may click a link that sends a request to the Customer Acquisition Server 102. At Step 610, the Customer Acquisition Server 102 may attribute the acceptance of the invitation to the first user. The Customer Acquisition Server 102 may then reward the first user at Step 612, after which the process ends at Step 614.

FIG. 7 illustrates another example method of rewarding a user with a good or service which can be done after a campaign or link has been shared with the user. In the method described above, the user who has had a campaign or link shared with them is not yet a known user of the system. The system records that a potential user has had a good or service awarded to them. When the potential user registers with the system, they will have the good or service assigned to them after the system recognizes this new user as the potential user with whom something had been shared.

For example, at Step 702, the Customer Acquisition Server 102 may request that an existing user (e.g., a first user) invite other users (e.g., a second user) to become a member of the Customer Acquisition Network 100. In doing so, the Customer Acquisition Server 102 may request that a first user share contact information for a second user at Step 702, via, for example, email, SMS, etc. Examples of such contact information would include an email address, physical address, telephone number, etc.

At Step 704, the Customer Acquisition Server 102 may receive said contact information. At Step 706, the Customer Acquisition Server 102 may create a record. That is, the Customer Acquisition Server 102 may store a record of the contact information for the second user, and that the contact information for the second user was submitted by the first user, to a non-transitory data storage device 102b coupled to the Customer Acquisition Server 102's computer 102a. At Step 708, the second user may register (e.g., sign up) using the contact information, or a portion thereof. At Step 710, the Customer Acquisition Server 102 may attribute the acceptance of the invitation to the first user based upon the matching contact information, or matching portions of said contact information. The Customer Acquisition Server 102 may then reward the first user at Step 712, after which the process ends at Step 714.

Any patents, patent publications, or articles cited herein are hereby incorporated by reference in their entirety. Although various embodiments have been described with reference to a particular arrangement of parts, features, and the like, these are not intended to exhaust all possible arrangements or features, and indeed many other embodiments, modifications, and variations will be ascertainable to those with skill in the art. Thus, it is to be understood that the invention may therefore be practiced otherwise than as specifically described above.

What is claimed is:

1. A customer acquisition system for targeting potential customers, the customer acquisition system comprising:
a non-transitory data storage device having one or more databases embodied therein;
a data transmission device; and
a processor operatively coupled to the non-transitory data storage device and the data transmission device,
wherein the processor is communicatively coupled with an on-site user device positioned at a merchant and configured to interact with a user via a customer interface apparatus,
wherein the processor receives, via said on-site user device, user visit data reflecting the user's activities with the merchant during a visit,
wherein the processor is configured to access an offer database stored to the non-transitory data storage device, the offer database comprising a plurality of offers,
wherein the processor uses said user visit data to identify one or more of said plurality of offers to be sent to the user for consideration, and
wherein the processor communicates said one or more of said plurality of offers to said user via said data transmission device.

2. The customer acquisition system of claim 1, wherein the on-site user device is configured to identify the user using an optical reader coupled to the on-site user device and QR Code positioned on the customer interface apparatus.

3. The customer acquisition system of claim 1, wherein the on-site user device is configured to identify the user and to wirelessly communicate with the customer interface apparatus using a wireless transceiver.

4. The customer acquisition system of claim 1, wherein the processor identifies said one or more of said plurality of offers by: (1) determining the merchant's category of goods or services; and (2) identifying one or more of said plurality of offers by other merchants having the same category of goods or services.

5. The customer acquisition system of claim 1, wherein the processor identifies said one or more of said plurality of offers by: (1) determining the merchant's location; and
(2) identifying one or more of said plurality of offers by other merchants having a location within a predetermined distance of said merchant's location.

6. The customer acquisition system of claim 1, wherein the processor identifies said one or more of said plurality of offers by: (1) determining the merchant's category of goods or services; (2) determining the merchant's location; and (3) identifying one or more of said plurality of offers by other merchants having (a) the same category of goods or services and (b) a location within a predetermined distance of said merchant's location.

7. The customer acquisition system of claim 1, wherein the processor stores said user visit data to a user profile database stored to the non-transitory data storage device, the user profile database comprising a plurality of user profiles.

8. The customer acquisition system of claim 7, wherein at least one of said plurality of user profiles comprises historic visit data reflecting user visit data associated with the user's prior transactions with the merchant or other merchants.

9. The customer acquisition system of claim 8, wherein the processor identifies said one or more of said plurality of offers by: (1) accessing historic visit data associated with the user's user profile; (2) determining, from said historic visit data, two or more categories descriptive of the user's prior transactions; and (3) identifying one or more of said plurality of offers by other merchants matching said two or more categories descriptive of the user's prior transactions.

10. The customer acquisition system of claim 9, wherein a weight is assigned to at least one of said two or more categories descriptive of the user's prior transactions, thereby giving greater significance to said at least one of said two or more categories when identifying one or more of said plurality of offers by other merchants.

11. A method for targeting potential customers, the method comprising:
receiving, at a computer via a data transmission device coupled to an on-site user device positioned at a merchant and configured to interact with a user via a customer interface apparatus, said user visit data reflecting the user's activities with the merchant during a visit;
accessing, via said computer, an offer database stored to the non-transitory data storage device, the offer database comprising a plurality of offers;
identifying one or more of said plurality of offers to be sent to the user for consideration; and
communicating said one or more of said plurality of offers to said user via said data transmission device.

12. The method of claim 11, wherein the on-site user device is configured to identify the user using an optical reader coupled to the on-site user device and QR Code positioned on the customer interface apparatus.

13. The method of claim 13, wherein the on-site user device is configured to identify the user and to wirelessly communicate with the customer interface apparatus using a wireless transceiver.

14. The method of claim 13, further comprising the steps of: (1) determining, using the computer, the merchant's category of goods or services; and (2) identifying, using the computer, one or more of said plurality of offers by other merchants having the same category of goods or services.

15. The method of claim 13, further comprising the steps of: (1) determining, using the computer, the merchant's location; and (2) identifying, using the computer, one or more of said plurality of offers by other merchants having a location within a predetermined distance of said merchant's location.

16. The method of claim 13, further comprising the steps of: (1) determining, using the computer, the merchant's category of goods or services; (2) determining, using the computer, the merchant's location; and (3) identifying, using the computer, one or more of said plurality of offers by other merchants having (a) the same category of goods or services and (b) a location within a predetermined distance of said merchant's location.

17. The method of claim 16, further comprising the step of storing said user visit data to a user profile database stored to the non-transitory data storage device, the user profile database comprising a plurality of user profiles, wherein at least one of said plurality of user profiles comprises historic visit data reflecting user visit data associated with the user's prior transactions with the merchant or other merchants.

18. The method of claim 17, further comprising the steps of: (1) accessing historic visit data associated with the user's user profile; (2) determining, from said historic visit data, two or more categories descriptive of the user's prior transactions; and (3) identifying one or more of said plurality of offers by other merchants matching said two or more categories descriptive of the user's prior transactions.

19. The method of claim 18, further comprising the step of assigning a weight to at least one of said two or more categories descriptive of the user's prior transactions, thereby giving greater significance to said at least one of said two or more categories when identifying one or more of said plurality of offers by other merchants.

20. A customer acquisition system for targeting potential customers, the customer acquisition system comprising:
a customer interface apparatus;
an on-site user device positioned at a merchant and configured to interact with a user via said customer interface apparatus,
wherein the on-site user device is configured to identify the user and to wirelessly communicate with the customer interface apparatus using a wireless transceiver; and
a customer acquisition server having a computer communicatively coupled to a non-transitory data storage device, the customer acquisition server being configured to communicate with said on-site user device over a communication network,
wherein the computer receives, via said on-site user device, user visit data reflecting the user's activities with the merchant during a visit,
wherein the computer is configured to access an offer database stored to the non-transitory data storage device, the offer database comprising a plurality of offers,
wherein the computer uses said user visit data to identify one or more of said plurality of offers to be sent to the user for consideration, and
wherein the computer communicates said one or more of said plurality of offers to said user via said communication network.
